(19) United States
(12) Patent Application Publication
(10) Pub. No.: US 2003/0095771 A1
(43) Pub. Date: May 22, 2003

(54) Planar lightwave circuit with polynominal-curve waveguide

(76) Inventor: Heu-Gon Kim, Seoul (KR)

Correspondence Address: CHA & REITER, 411 HACKENSACK AVE, 9TH FLOOR, HACKENSACK, NJ, 07601, US

(21) Appl. No.: 10/159,448

(22) Filed: May 31, 2002

(30) Foreign Application Priority Data
Nov. 13, 2001 (KR) 2001-70579

(51) Int. Cl. G02B 6/122

(52) U.S. Cl. 385/129; 385/14

(57) ABSTRACT

A planar lightwave circuit with a polynominal-curve waveguide of the type having a semi-conductive substrate, a plurality of cores disposed on the substrate, which act as a medium transmitting optical signals, and a clad surrounding the plurality of cores, wherein each of the cores is comprised of at least one straight optical waveguide and at least one polynominal-curve optical waveguide connected to the straight optical waveguide, the curve being defined by a polynominal equation.

### CLAIM OF PRIORITY

This application makes reference to and claims all benefits accruing under 35 U.S.C. Section 119 from an application entitled, “PLANAR LIGHTWAVE CIRCUIT WITH POLYNOMINAL-CURVE WAVEGUIDE,” filed in the Korean Industrial Property Office on Nov. 13, 2001 and there duly assigned Serial No. 2001-70579.

### BACKGROUND OF THE INVENTION

1. Field of the Invention

The present invention relates to an optical circuit, and more particularly to a planar lightwave circuit having a plurality of waveguides for use in an optical communication system.

2. Description of the Related Art

Many researches have concentrated on developing integrated optics for optical communication systems. Integrated optics are becoming popular for their small size, low cost, low power consumption, and high-speed performance when compared to a system that utilizes an assembly of separate optical components. For a while, there has been a slow gain in its actual applications to the field of optical communications as there are limitations in the process and high cost associated with fabricating dielectric waveguides using LiNbO₃ and semiconductor waveguides using GaAs and InP. Recently, several techniques have been proposed, including a technique of manufacturing a planar lightwave circuit employing silica-based cores disposed on a silicon substrate, and a newer technique of disposing light emitting and receiving elements on the substrate. Accordingly, the technique of incorporating integrated optical components, such as a coupler, beam splitter, and a wavelength-division multiplexer, in the field of optical communications has grown. The planar lightwave circuit employing a process used in a semiconductor integrated circuit has been deployed as it provides an efficient alternative in terms of its manufacturing cost as well as its functionality. For example, it is known that a conventional optical fiber is an excellent choice to serve as a beam splitter to make the beam separate into four branches (1×4). However, for more than four branches, a planar lightwave circuit is more advantageous in the beam-splitting applications as it can be mass-produced at a relatively low cost. When manufacturing the planar lightwave circuit, a variety of materials can be used. Among those, silica is the best material in terms of transmission loss, connection loss, and temperature stability.

FIG. 1 shows an exemplary planar lightwave circuit in accordance with a conventional technique, and FIG. 2 shows a core illustrated in FIG. 1. The planar lightwave circuit 100 comprises a semi-conductive substrate (not illustrated), a plurality of cores 110 disposed on the substrate, which act as a medium transmitting optical signals, and a clad 120 surrounding the plurality of cores.

Each of the cores 110 is comprised of a first straight optical waveguide 112 into which external optical signals are inputted therethrough, and an arc optical waveguide 114 connecting the first straight optical waveguide 112 which can be defined by Equation 1 below.

A(x,y)=(x−a)²+(y−b)²−R²=0 [Equation 1]

The Equation 1 denotes a circular equation, wherein a and b represent a certain real number and a radius of the circle, respectively.

Referring to FIG. 2, an arc optical waveguide 114 is represented as an arc, that is, a part of the circle, which is defined by the above Equation 1. The radius R₁ and central angle of the arc are set so as to optimize optical-signal loss generated in connection points between the first straight optical waveguide 112 and the arc optical waveguide 114, and between the arc optical waveguide 114 and the second straight optical waveguide 116.

FIG. 3 shows a mode mismatch that is typically generated in the connection point between the arc optical waveguide 114 and the first straight optical waveguides 112 illustrated in FIG. 2. As shown in FIG. 3, a first propagating mode 150 of the first straight optical waveguides 112 and a second propagating mode 160 of the arc optical waveguide 114 are mismatched. That is, a central line of the first propagating mode 155 and a central line of the second propagating mode 165 are mismatched. Also, the profiles of the first propagating mode 150 and the second propagating mode 160 are mismatched from each other. As a result, the signals traveling to the arc optical waveguide 114 section through the first straight optical waveguides 112 are partially lost (this is called transition loss) due to the mismatch-mode phenomenon. Such transition loss can be minimized by increasing the radius of the arc optical waveguide 114. However, this approach has a shortcoming in that the volume of the planar lightwave circuit 100 is increased.

FIG. 4 shows a planar lightwave circuit in accordance with another conventional technique, and FIG. 5 shows the core illustrated in FIG. 4. The planar lightwave circuit 200 comprises a semi-conductive substrate (not illustrated), a plurality of cores 210 disposed on the substrate, which act as a medium transmitting optical signals, and a clad 220 surrounding the plurality of cores.

Each of the cores 210 is comprised of a first straight optical waveguide 212 into which external optical signals are inputted there-through, and S-shaped optical waveguides 214 and 216, one of which is connected to the first straight optical waveguide 212.

The S-shaped optical waveguides 214 and 216 consist of a first arc optical waveguide 214 with a radius R₂ and a second arc optical waveguide 216 with a radius R₃. The first arc optical waveguide 214 is connected to the first straight optical waveguide 212, and the second arc optical waveguide 216 is connected to the second straight optical waveguide 218. Such S-shaped optical waveguides 214 and 216 thus have three connection points, that is, a connection between the first straight optical waveguide 212 and the first arc optical waveguide 214, a connection C₁ between the first arc optical waveguide 214 and the second arc optical waveguide 216, and a connection between the second arc optical waveguide 216 and the second straight optical waveguide 218. As such, transition loss is generated in these connection points. In terms of volume reduction, the S-shaped optical waveguides 214 and 216 are superior over the arc optical waveguides shown in FIG. 2.

FIG. 6 shows the transition loss in the S-shaped optical waveguides 214 and 216 illustrated in FIG. 5. As shown in FIG. 6, with regard to the S-shaped optical waveguides 214 and 216, a first propagating mode 250 of the first arc optical waveguides 214 and a second propagating mode 260 of the second arc optical waveguide 216 are mismatched. That is, a central line 255 of the first propagating mode and a central line 265 of the second propagating mode are mismatched. Also, the profiles of the first propagating mode 250 and the second propagating mode 260 are mismatched.

FIG. 7 shows the volume reduction effect of an S-shaped optical waveguide 320. As shown when the S-shaped optical waveguide 320 is used, a relatively narrow width W₂ (that is, W₂<W₁) can be used to reach the same height H₁ compared to the arc optical waveguide 310 in FIG. 2. Thus, a planar lightwave circuit employing the S-shaped optical waveguide 320 is advantageous over the arc optical waveguide 310 as its volume can be reduced.

However, as described above, there is a problem in that both the arc optical waveguide and the S-shaped optical waveguide experience a transition loss of optical signals. Furthermore, when a radius of the arc in question is increased to reduce the transition loss, the volume of the planar lightwave circuit must be increased.

To overcome the above problems, a method of applying an offset to the arc optical waveguide or S-shaped optical waveguide has been proposed in the art.

FIG. 8A shows an arc optical waveguide with the offset scheme. The arc optical waveguide includes a first straight optical waveguide 410, an arc optical waveguide 420 and a second straight optical waveguide 430. FIG. 8B shows the transition loss in the arc optical waveguide illustrated in FIG. 8A. A certain value of an offset F₁ is given in the connection point between the first straight optical waveguide 410 and the arc optical waveguide 420. The offset F₁ is set within a predetermined range to make the propagating modes of the first straight optical waveguide 410 and the arc optical waveguide 420 to be matched with each other. Similarly, a predetermined value of an offset F₂ is given in the connection point between the arc optical waveguide 420 and the second straight optical waveguide 430. The offset F₂ is set within a certain desired range to make the propagating modes of the second straight optical waveguide 430 and the arc optical waveguide 420 to match each other. However, although the two central lines 470 of the first mode and the second mode match each other, the profiles of the first propagating mode 450 and the second propagating mode 460 are mismatched from each other. In particular, the first propagating mode 450 of the first straight optical waveguide 410 and the second propagating mode 460 of the arc optical waveguide 420 are still mismatched.

FIG. 9A shows an S-shaped optical waveguide applying the offset scheme. FIG. 9B shows the transition loss in the optical waveguides illustrated in FIG. 9A. The S-shaped optical waveguides 510 and 520 consist of a first arc optical waveguide 510 with a radius R₁ and a second arc optical waveguide 520 with a radius R₂. A certain value of an offset F₃ is given in a connection point between the first arc optical waveguide 510 and the second arc optical waveguide 520. The offset F₃ is set within a certain desired range to make the propagating modes of the first arc optical waveguide 510 and the second arc optical waveguide 520 match each other. However, although the two central lines 470 of the first mode and the second mode match each other, the profiles of the first propagating mode 550 and the second propagating mode 560 are mismatched. That is, the first propagating mode 550 of the first arc optical waveguide 510 and the second propagating mode 560 of the second arc optical waveguide 520 are still mismatched

As described in the above, a planar lightwave circuit employing the conventional arc optical waveguides or S-shaped optical waveguides still has shortcomings. Firstly, the arc optical waveguides cause a transition loss of optical signals. To decrease such transition loss, the radii of the arcs can be increased, but the total volume of the planar lightwave circuit is increased. Alternatively, by applying an offset, the transition loss can be decreased but the profiles of the propagating modes are still mismatched. Furthermore, as the offset should be applied accurately to the waveguide, the manufacturing time is delayed.

Secondly, compared to the arc optical waveguides, the S-shaped optical waveguides are superior in terms of the volume reduction of a planar lightwave circuit, but the transition loss of optical signals is generated also. With the application of an offset scheme, the transition loss can be decreased as in the case of the arc optical waveguide.

### SUMMARY OF THE INVENTION

Therefore, the present invention has been made to overcome the above problems by providing a planar lightwave circuit that is capable of minimizing the transition loss of optical signals without increasing the circuit size.

In accordance with the present invention, a planar lightwave circuit includes a semi-conductive substrate, a plurality of cores disposed on the substrate, which act as medium transmitting optical signals, and a clad surrounding the plurality of cores, wherein each of the cores is comprised of at least one straight optical waveguide, and at least one polynominal-curve optical waveguide, with which the straight optical waveguide is connected, the curve being defined by a polynominal equation.

### BRIEF DESCRIPTION OF THE DRAWINGS

The above and other features and advantages of the present invention will be understood more clearly from the following detailed description taken in conjunction with the accompanying drawings, in which:

FIG. 1 shows a planar lightwave circuit in accordance with a conventional art system;

FIG. 2 illustrates the core depicted in FIG. 1;

FIG. 3 is a graph showing a mode mismatch generated in the connection point between an arc optical waveguide and a straight optical waveguide illustrated in FIG. 2;

FIG. 4 shows a planar lightwave circuit in accordance with another conventional art system;

FIG. 5 illustrates the core depicted in FIG. 4;

FIG. 6 is a graph showing the transition loss in S-shaped optical waveguides illustrated in FIG. 5.

FIG. 7 shows the volume reduction effect of S-shaped optical waveguides;

FIG. 8A shows an arc optical waveguide applying an offset scheme;

FIG. 8B is a graph showing the transition loss in the arc optical waveguide illustrated in FIG. 8A;

FIG. 9A is a drawing showing an S-shaped optical waveguide applying an offset scheme;

FIG. 9B is a graph showing the transition loss in arc optical waveguides illustrated in FIG. 9A;

FIG. 10 shows a planar lightvave circuit in accordance with a preferred embodiment of the invention;

FIG. 11 illustrates the core depicted in FIG. 10;

FIG. 12 is a graph showing a mode match generated in the connection point between a polynominal-curve optical waveguide and a first straight optical waveguide, and a mode match generated in the inflection point of the polynominal-curve optical waveguides, illustrated in FIG. 11;

FIG. 13 is a view showing the volume reduction effect of a polynominal-curve optical waveguide;

FIG. 14 shows a planar lightwave circuit in accordance with another preferred embodiment of the invention; and,

FIG. 15 illustrates the core depicted in FIG. 14.

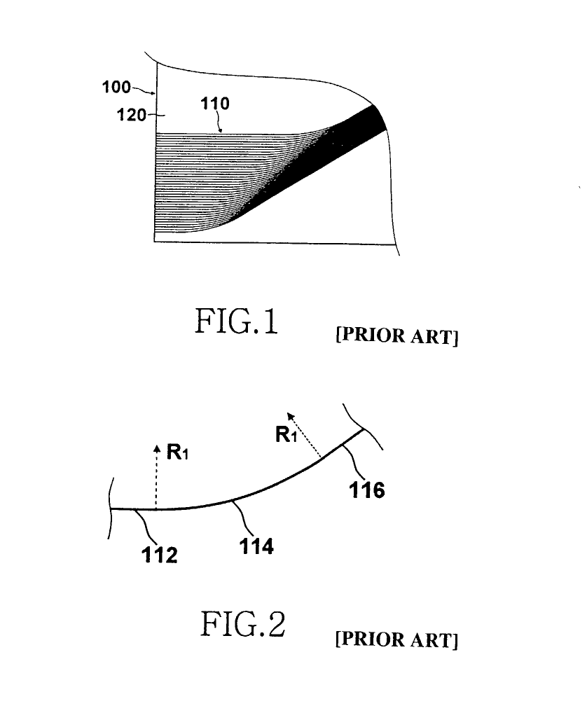

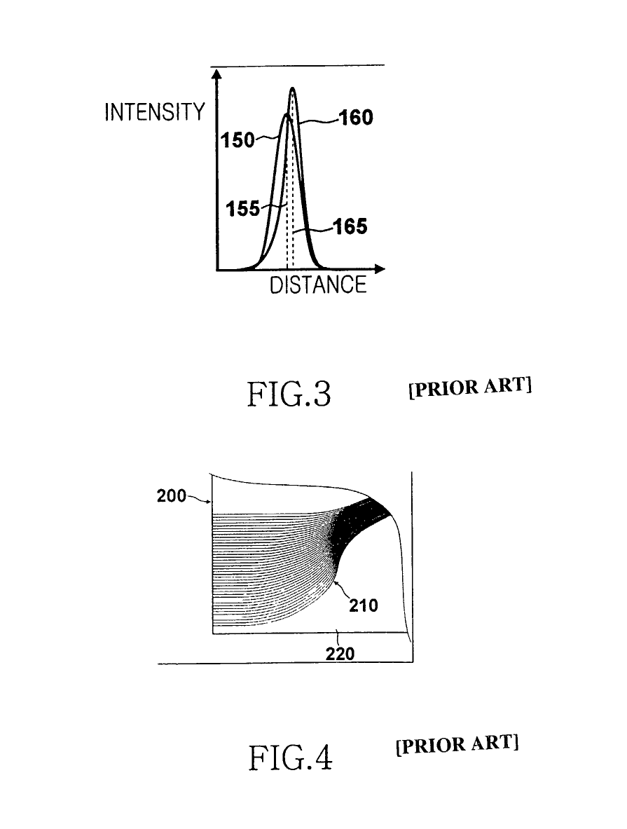

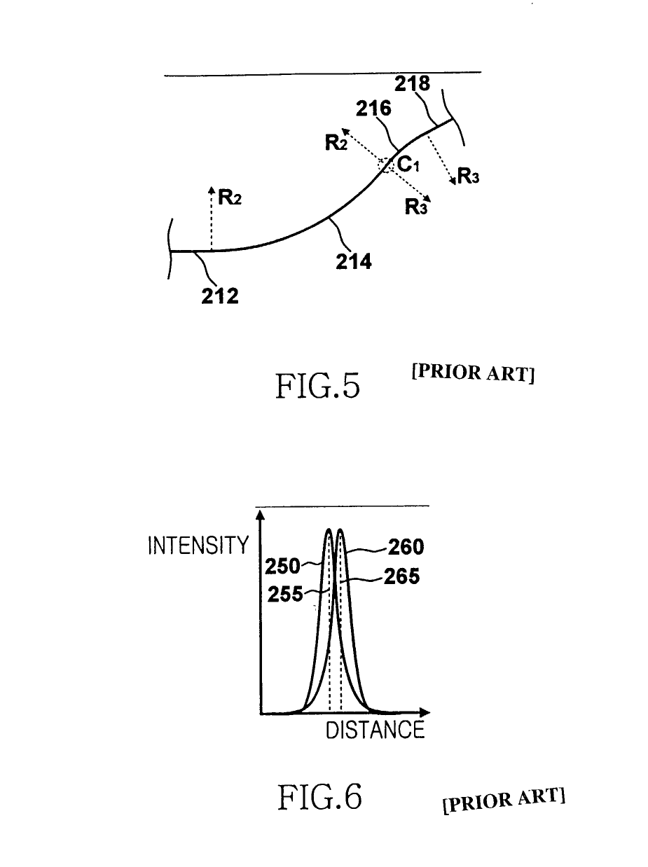

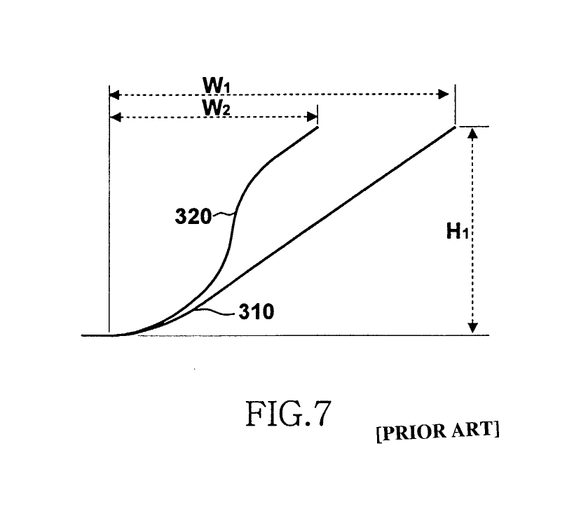

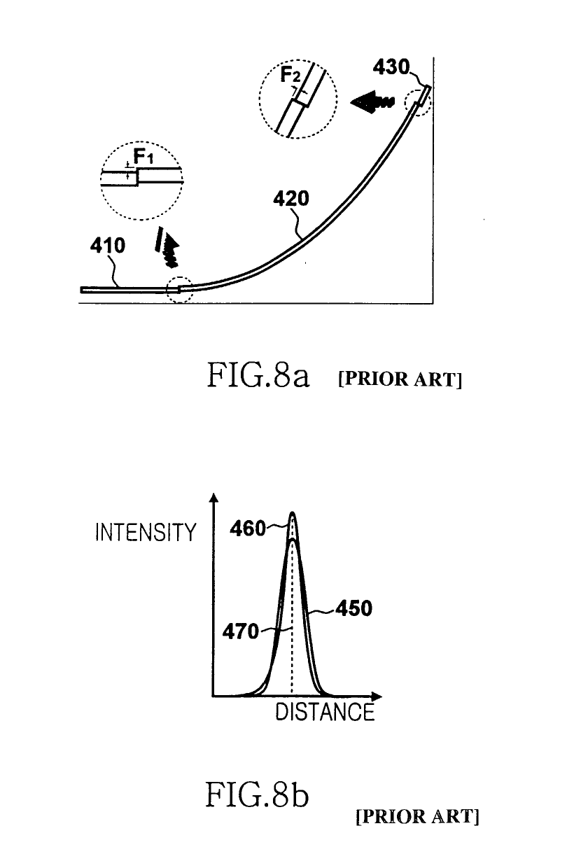

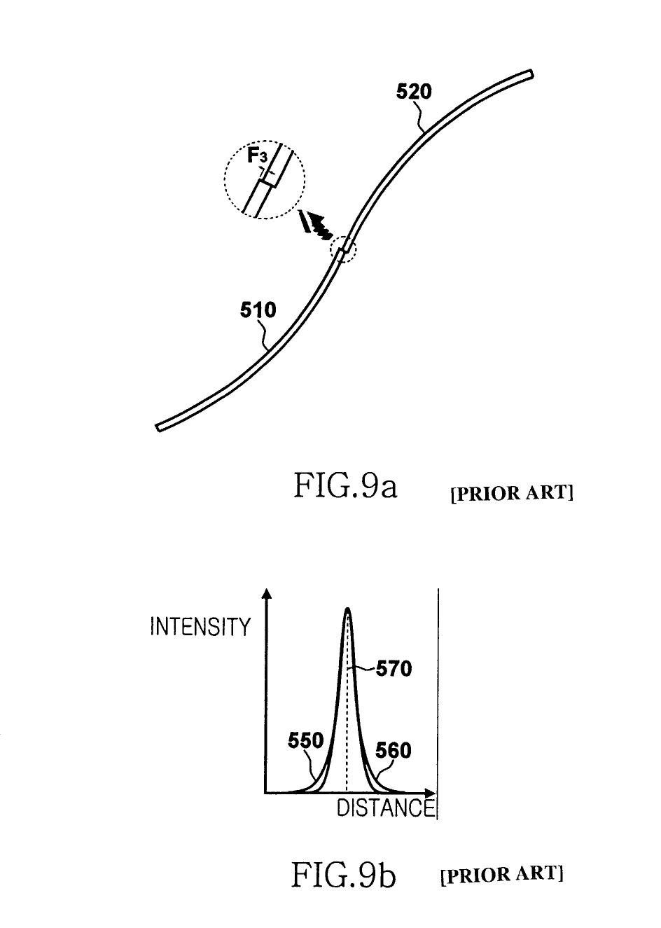

### DETAILED DESCRIPTION OF THE PREFERRED EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

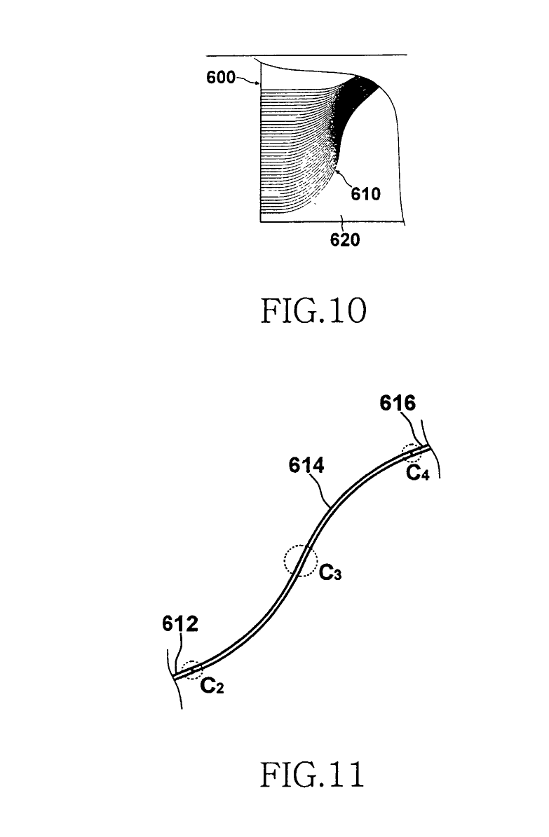

FIG. 10 shows a planar lightwave circuit in accordance with a preferred embodiment of the invention, and FIG. 11 depicts the core illustrated in FIG. 10. The planar lightwave circuit 600 according to the present invention includes a semi-conductive substrate (not illustrated), a plurality of cores 610 disposed on the substrate, which act as a medium transmitting optical signals, and a clad 620 surrounding the plurality of cores.

Each of the cores 610 is comprised of a first straight optical waveguide 612 into which external optical signals are inputted there-through, and a polynominal-curve optical waveguide 614 coupled to the first straight optical waveguide 612. The curve optical waveguide 614 is defined by Equation 2 below.

$$A ( x ) = {\sum }_{n = 0}^{K} {a}_{n} {x}^{n} \qquad \text{[Equation 2]}$$

The Equation 2 denotes a polynominal equation, K represents an integer of 3 or more, and aₙ represents an iz-th coefficient.

The above polynominal equation A(x) is set to minimize the transition loss of optical signals generated within the polynominal-curve optical waveguide 614. Due to the characteristics of a polynominal curve, the transition loss is not generated in three points C₂, C₃ and C₄, that is, a connection point C₂ between the first straight optical waveguide 612 and the polynominal-curve optical waveguide 614, a connection point C₄ between the polynominal-curve optical waveguide 614 and a second straight optical waveguide 616, and an inflection point C₃ of the polynominal-curve optical waveguide 614. Unlike the prior art system where the transition loss is generated between the straight optical waveguide and the arch optical waveguide, the polynominal-curve optical waveguide 614 according to the embodiment of the present invention makes a continuous polynominal curve, as shown in FIG. 11, thereby generating little or no transition loss at the intersection points.

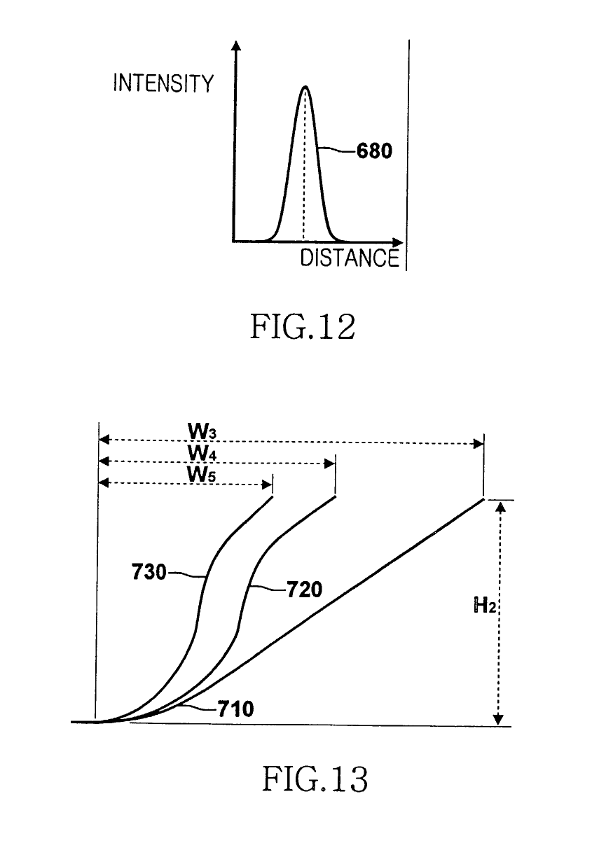

FIG. 12 is a graph showing a mode match generated in three points, that is, the connection point C₂ between the first straight optical waveguide 612 and the polynominal-curve optical waveguide 614, the connection point C₄ between the polynominal-curve optical waveguide 614 and the second straight optical waveguide 616, and the inflection point C₃ of the polynominal-curve optical waveguide 614.

As shown in FIG. 12, since a continuous polynominal curve is made in the connection point C₂ between the first straight optical waveguide 612 and the polynominal-curve optical waveguide 614, the connection point C₄ between the polynominal-curve optical waveguide 614 and the second straight optical waveguide 616, and the inflection point C₃ of the polynominal-curve optical waveguide 614, a matched propagating mode 680 is generated, thus indicating that there is little or no transition loss of optical signals in the inflection point C₃.

FIG. 13 shows the volume-reduction effect of the polynominal-curve optical waveguide according to the present invention with the prior art systems. As shown, compared to an S-shaped optical waveguide 720 or an arc optical waveguide 710, when a polynominal-curve waveguide 730 is used, a relatively narrow width W₅ (that is, W₅<W₄<W₃) can be used to reach the same height H₂. Thus, a planar lightwave circuit employing the polynominal-curve optical waveguide 730 is advantageous as the volume can be reduced when compared to the use of the S-shaped optical waveguide 720 or the arc optical waveguide 710.

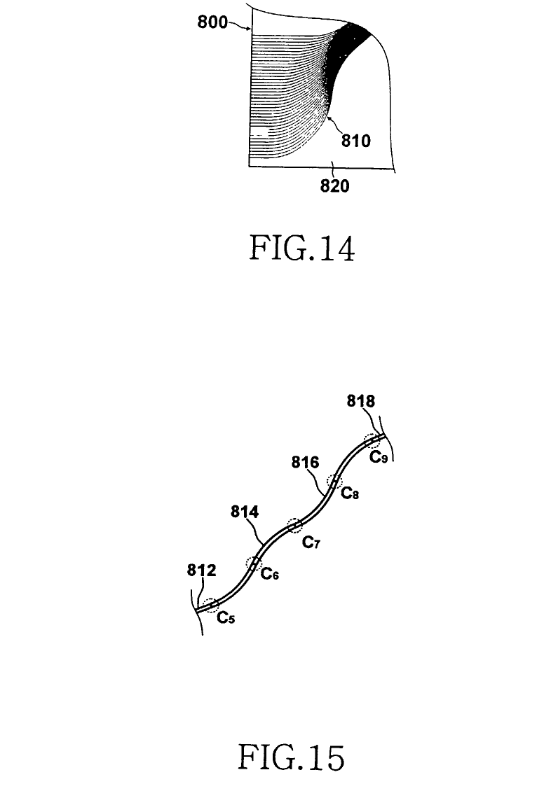

FIG. 14 shows a planar lightwave circuit in accordance with another preferred embodiment of the invention. FIG. 15 depicts the core illustrated in FIG. 14. The planar lightwave circuit 800 according to the present invention includes a semi-conductive substrate (not illustrated), a plurality of cores 810 disposed on the substrate, which act as a medium transmitting optical signals, and a clad 820 surrounding the plurality of cores. Furthermore, each of the cores is comprised of a straight optical waveguide 812 into which external optical signals are inputted through at one end, and polynominal-curve optical waveguides 814 and 816 coupled to the straight optical waveguide in series. The polynominal-curve optical waveguides 814 and 816 consist of a first sub-polynominal—curve optical waveguide 814, defined by Equation 3 below, and a second sub-polynominal—curve optical waveguide 816, defined by Equation 4 below.

$$B ( x ) = {\sum }_{n = 0}^{L} {b}_{n} {x}^{n} \qquad \text{[Equation 3]}$$

The Equation 3 denotes a polynominal equation, L represents an integer of 3 or more, and bₙ represents an n-th coefficient.

$$C ( x ) = {\sum }_{n = 0}^{M} {c}_{n} {x}^{n} \qquad \text{[Equation 4]}$$

The Equation 4 denotes a polynominal equation, M represents an integer of 3 or more, and cₙ represents an n-th coefficient.

The above polynominal equations B(x) and C(x) are set to minimize the transition loss of optical signals generated within the polynominal-curve optical waveguides 814 and 816. Due to the characteristics of a polynominal curve, the transition loss is not generated in five points C₅, C₆, C₇, C₈ and C₉, that is, a connection point C₅ between the first straight optical waveguide 812 and the first sub-polynominal—curve optical waveguide 814, an inflection point C₆ of the first sub-polynominal—curve optical waveguide 814, a connection point C₇ between the first sub-polynominal—curve optical waveguide 814 and the second sub-polynominal—curve optical waveguide 816, an inflection point C₈ of the second sub-polynominal—curve optical waveguide 816, and a connection point C₉ between the second sub-polynominal—curve optical waveguide 816 and a second straight optical waveguide 818. In the embodiment, the polynominal-curve optical waveguides 814 and 816 make a continuous polynominal-curve, thereby generating little or no transition loss at the intersection points.

As described above, it is possible that the planar lightwave circuit according to the present invention can be fabricated diversely by employing polynominal-curve optical waveguides.

Table 1 below shows the transmission loss of a polynominal-curve optical waveguide obtained through a simulation according to the present invention as well as the prior art waveguides.

Transmission Loss (dB)

| | | Two connected |
|---|---|---|
| Types of waveguides | One waveguide | waveguides |
| arc optical waveguide | 0.01039 dB | 0.3391 dB |
| arc optical waveguide | 0.0097 dB | 0.0405 dB |
| applying offset | | |
| Polynominal-curve optical | 0.0032 dB | 0.0048 dB |
| waveguide of the present | | |
| invention | | |

In Table 1, the arc optical waveguide has a radius of 5000 μm, and a central angle of the arc is 10°. The difference n of refraction indices between the arc optical waveguide and the clad is 0.75%. The polynominal-curve optical waveguide has the same height as the arc optical waveguide. The difference n of refraction indices between the polynominal-curve optical waveguide and clad is 0.75%.

As apparent from the above description, according to the present invention, a planar lightwave circuit with a polynominal-curve waveguide has an advantage in that transition loss of optical signals as well as the volume of the planar lightwave circuit can be minimized, by employing polynominal-curve waveguides having a continuous polynominal curve.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A planar lightwave circuit comprising:
a semi-conductive substrate;
a plurality of cores disposed on the substrate for transmitting optical signals;
a clad surrounding the plurality of cores, each of the cores including at least one straight optical waveguide and at least one polynominal-curve optical waveguide coupled to the straight optical waveguide is connected,
wherein the polynominal-curve optical waveguide satisfies equation,
$$A ( x ) = {\sum }_{n = 0}^{K} {a}_{n} {x}^{n} ,$$
where A(x) denotes a polynominal equation, K denotes an integer of 3 or higher, and aₙ represents an n-th coefficient.

2. The planar lightwave circuit as set forth in claim 1, wherein the polynominal-curve optical waveguide consists of a plurality of sub-polynominal—curve optical waveguides connected in series.

3. A lightwaveguide circuit including a plurality of waveguides, wherein each of said waveguides comprises a core and a clad, and each of said waveguides is formed in the shape of a polynominal curve.

4. The lightwaveguide circuit of claim 3, wherein the polynominal curve satisfies equation,
$$A ( x ) = {\sum }_{n = 0}^{K} {a}_{n} {x}^{n} ,$$
where A(x) denotes a polynominal equation, K denotes an integer of 3 or higher, and aₙ represents an n-th coefficient.

5. The lightwaveguide circuit of claim 3, wherein each of the waveguides further includes a plurality of sub-polynominal—curve waveguides connected in series.

6. The lightwaveguide circuit of claim 3, wherein each of the waveguides is shaped in a continuous polynominal curve.
